(19) United States
(12) Patent Application Publication
(10) Pub. No.: US 2025/0002406 A1
(43) Pub. Date: Jan. 2, 2025

(54) GRAPHENE DISPERSION

(71) Applicant: Concretene Ltd., Salisbury, Wilshire (GB)

(72) Inventors: Craig Dawson, Salisbury, Wilthsire (GB); Lisa Scullion, Salisbury, Wilthsire (GB); Happiness Ijije, Salisbury, Wilthsire (GB)

(73) Assignee: Concretene Ltd., Salisbury, Wiltshire (GB)

(21) Appl. No.: 18/704,852

(22) PCT Filed: Oct. 26, 2022
(86) PCT No.: PCT/EP2022/079980

§ 371 Date: Apr. 25, 2024

(30) Foreign Application Priority Data
Oct. 27, 2021 (GB) 2115442.2

(51) Int. Cl. C04B 14/02; C04B 40/00

(52) U.S. Cl. CPC C04B 14/026; C04B 40/0046

(57) ABSTRACT

Provided are stable dispersions of graphene nanoplatelets in water, and methods for manufacturing such dispersions.

### FIELD OF THE INVENTION

The present invention relates to a graphene dispersion, particularly in the form of an additive for introducing graphene into compositions such as concrete, and methods of making them.

### BACKGROUND

Graphene has been much researched since its isolation in 2004. It has been suggested as a possible reinforcement nanomaterial for building materials, for example in WO 2019/175564 and WO 2017/092778. Indeed it has been much discussed as a potentially useful additive for a wide variety of purposes, from inks to polymer composites.

A commonly faced problem is in the dispersion of graphene within another composition or material. In general, graphene tends to agglomerate, leading to an uneven distribution through a (for example) liquid phase. Accordingly graphene has only been successfully suspended in (for example) water at very low concentration. In general much higher levels are needed to provide an economical additive for use in a wide range of applications. There remains a need, then, for suspensions including higher levels of graphene.

Furthermore, previous efforts to suspend graphene in water have led to results with very limited stability (“shelf life”). Because of the tendency to agglomerate, even low concentration levels of graphene only remain uniformly dispersed for relatively short periods of time, in the order of hours. This means that such suspensions are not practical for large scale manufacture as they must be used very soon after being formed. There remains a need for suspensions which have a stability towards days or even months, which allow them to be used industrially with greater ease.

Both of these problems are of significance in a variety of industries, for example construction (where it is desirable to include graphene in materials such as concrete).

The present invention has been devised in light of the above considerations.

### SUMMARY OF THE INVENTION

At its broadest, the present invention relates to a graphene nanoplatelet dispersion.

The dispersion comprises water with graphene nanoplatelets (GNP) and graphene oxide (GO), both ideally being substantially uniformly distributed therein. The methods that are subject of the present invention, to make such a dispersion, permit significantly higher levels of GNP and GO to be suspended in the water than have previously been achieved. Furthermore, the methods lead to suspensions which are remarkably stable over time.

In a first aspect, then, the present invention provides a graphene dispersion, comprising: (a) graphene nanoplatelets; (b) graphene oxide nanoplatelets; and (c) water, wherein the concentration of graphene nanoplatelets in the additive is from 29 mg·ml⁻¹ to 150 mg·ml⁻¹ and the concentration of graphene oxide nanoplatelets in the additive is from 1 mg·ml⁻¹ to 50 mg·ml⁻¹.

The dispersion of GNP and GO is preferably substantially uniform within the water.

Preferably, the total graphene material content in the dispersion is greater than or equal to 30 mg·ml⁻¹.

A stable dispersion with these levels of GO and GNP loadings has not been known in the prior art. The present inventors have made dispersions of this type which are stable for more than 6 months, permitting them to be added in a concrete batching plant. This is a significant advantage over previous, less long lived dispersions, even at lower loading levels, which would need to be made in situ to permit dispersion in a further composition.

The inventors have found that a larger flake size of the GNP may be preferable. Accordingly, in some embodiments, the graphene nanoplatelets have an average lateral flake dimension of greater than 1 μm, preferably greater than 10 μm.

The inventors have also found that a smaller flake size of the GO may be preferable, to increase the surface area (and at % oxygen) and hence the availability of oxygen containing groups. Accordingly, in some embodiments, the graphene oxide nanoplatelets have an average lateral flake dimension of less than 0.9 μm.

As explained above, the present additives contain a significant level of GO and GNP. It may be preferred that the concentration ratio of graphene oxide nanoplatelets to graphene nanoplatelets, calculated as graphene oxide nanoplatelet concentration/graphene nanoplatelet concentration, is from 0.025 to 1. This can give an ideal balance of stability and potential property improvement.

A second aspect of the present invention relates to a method of making a graphene dispersion, the method comprising the steps of: (i) mixing graphene oxide nanoplatelets, or a graphene oxide precursor material, with water; (ii) mixing at high shear at at least 4000 rpm for at least 15 minutes; (iii) adding graphene nanoplatelets, or a graphene precursor material; and (iv) mixing at high shear at at least 4000 rpm for at least 15 minutes.

It is noted that step pairs (i) and (ii), and (iii) and (iv), may be switched in order. That is, the steps may be performed in the order (i) then (ii) then (iii) then (iv) or may be performed in the order (iii) then (iv) then (i) then (ii).

The high shear mixing may preferably (in one or both of steps (ii) and (iv)) be performed under conditions such that the shear rate is at least 1.5×10⁴ s⁻¹.

The graphene oxide precursor material may be, for example, graphite oxide. The graphene precursor material may be, for example, graphite.

In step (i) it may be that a graphene oxide or graphite oxide wetcake is mixed with the water.

In order to improve the distribution of the GO towards uniformity, it may be preferable that in step (ii) mixing is performed for at least 45 minutes, preferably about 1 hour.

In step (iii), it may be that a graphene nanoplatelets powder is added.

In order to improve the distribution of the GNP towards uniformity, it may be preferable that in step (iv) mixing is performed for at least 45 minutes, preferably about 1 hour.

For the reasons mentioned above, in step (iv) it may be preferable that graphene nanoplatelets with an average lateral flake dimension of greater than 1 μm, preferably greater than 10 μm, are used.

For the reasons mentioned above, in step (i) graphene oxide nanoplatelets or graphite oxide with an average lateral flake dimension of less than 0.9 μm are used.

Preferably, in step (i) the graphene oxide nanoplatelets or graphene oxide precursor material is added in an amount to give a graphene oxide nanoplatelet concentration of from 1 mg·ml⁻¹ to 50 mg·ml⁻¹ in the dispersion.

Preferably, in step (iii) the graphene nanoplatelets or graphene precursor material is added in an amount to give a graphene nanoplatelet concentration of from 29 mg·ml⁻¹ to 150 mg·ml⁻¹ in the dispersion.

Preferably, in steps (i) and (iii) the graphene oxide nanoplatelets or graphene oxide precursor material, and the graphene nanoplatelets or graphene precursor material, are added in an amount to give a concentration ratio of graphene oxide nanoplatelets to graphene nanoplatelets, calculated as graphene oxide nanoplatelet concentration/graphene nanoplatelet concentration, from 0.025 to 1 in the dispersion.

Another aspect of the present invention relates to a graphene dispersion obtainable or obtained by the methods described above. That is, it relates to a graphene dispersion obtainable or obtained by a method comprising the steps of: (i) mixing graphene oxide nanoplatelets, or a graphene oxide precursor material, with water; (ii) mixing at high shear at at least 4000 rpm for at least 15 minutes; (iii) adding graphene nanoplatelets, or a graphene precursor material; and (iv) mixing at high shear at at least 4000 rpm for at least 15 minutes, the steps being performed in the order (i) then (ii) then (iii) then (iv) or being performed in the order (iii) then (iv) then (i) then (ii).

Graphene dispersions obtained in this way may be stable for at least 24 hours, at least 48 hours, at least 1 week, at least 1 month or most preferably at least 6 months.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 illustrates the viscosity profile of an example dispersion of the invention on days 7 and 21.

FIG. 2 illustrates the viscosity profile of an example dispersion of the invention on days 3 and 7.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

### Definitions

Initially it is worth discussing the meaning of various terms of art that are used herein. Given the relatively young age of graphene based techniques, there has in the past been some variation in how particular terms are used with reference to it.

In particular, “graphene” is used to refer not only to monolayer graphene but also few layer graphene. The graphene nanoplatelets used herein preferably comprise 1-10 layers of monolayer graphene. Such graphene products are readily commercially available, and various methods of making graphene are well known.

“Graphene oxide” refers to graphene (as defined above) that has a significant amount of surface bound oxygen containing groups. For example, hydroxyl (C—OH), ketone (C═O), carboxyl (COOH), epoxide (C—O—C) and other species. Graphene oxide is readily commercially available, being obtained from various methods such as the Hummers process. It may be obtained by, for example, delamination of graphite oxide.

Herein, the concentrations of GNP and GO in the additive may be discussed in terms of weight content per millilitre of the final formulation of the additive, mg·ml⁻¹. The content can also be considered in terms of wt % of the final additive.

### Dispersion

The present dispersion is a dispersion of graphene, and graphene oxide, in water. It may be characterised by the high levels of GNP that are contained within a stable dispersion, or by its stability over time (that is, the time over which the graphene remains dispersed without significant agglomeration). Previous such dispersions have included significantly less GNP; and/or have been stable for significantly less time.

One way of judging stability of the dispersion is to measure its viscosity at certain time intervals (as viscosity is affected by agglomeration and hence dispersion instability, a significant rise in viscosity indicates a loss of stability).

For example, using a standard equipment such as a lab viscometer (for example the DV2T viscometer from AMETEK Brookfield, LV model) the viscosity of the dispersion can be measured directly after production (this may be referred to a V₀). Then, the viscosity can be measured by the same technique (same conditions; hence, the test for stability is independent of exactly what viscosity measurement technique or conditions are used) as a time ‘x’ hours later (this may be referred to as Vₓ). If the viscosity measured at time x is within about 35% of the viscosity originally measured (that is, if {([Vₓ/V₀]*100)−100} is less than or equal to 35) the dispersion can be said to be stable for at least ‘x’ hours.

The viscosity measured at time x may preferably be within about 25% of the viscosity originally measured to demonstrate stability, more preferably within about 20% and most preferably within about 15%.

The viscosity measurement may be performed at, for example, 30 rpm, 40 rpm, 50 rpm, 70 rpm, 90 rpm or 110 rpm, preferably at 40 rpm, at 21° C. Stability (the above mentioned Vₓ being within about 35% of V₀, preferably about 25% and so on) need only be demonstrated at at least one of 30 rpm, 40 rpm, 50 rpm, 70 rpm and 90 rpm to be considered satisfied in the present invention. However more preferably it is demonstrated at at least two of those rpm counts, more preferably at least four of those rpm counts, and most preferably at all of those rpm counts.

The dispersions of the present invention are preferably stable for at least 24 hours, more preferably at least 72 hours, yet more preferably at least 168 hours and most preferably at least 504 hours.

An alternative, or additional, indicator of stability can be by conducting a visual inspection of the dispersion after heating for a certain time. For example, a dispersion may be said to be stable if it can be subjected to heating for at least 5 days at at least 40° C. with no change in its visual appearance; for example subjected to heating for at least 7 days at at least 50° C. with no change in its visual appearance.

[A change of visual appearance here is indicative of the dispersion starting to separate.]

The dispersion itself may have a variety of viscosities depending on the contents. It may be in the form of a fluid, or a gel.

The present dispersions include (a) graphene nanoplatelets; (b) graphene oxide nanoplatelets; and (c) water, wherein the concentration of graphene nanoplatelets in the additive is from 29 mg·ml⁻¹ to 150 mg·ml⁻¹ and the concentration of graphene oxide nanoplatelets in the additive is from 1 mg·ml⁻¹ to 50 mg·ml⁻¹.

These higher concentrations are, it is believed, enabled by the manufacturing methods described hereinbelow. The concentration of GNP may preferably be from 50 mg·ml⁻¹ to 120 mg·ml⁻¹, and more preferably from 60 mg·ml⁻¹ to 100 mg·ml⁻¹. The concentration of GO may preferably be from 5 mg·ml⁻¹ to 45 mg·ml⁻¹, and more preferably from 15 mg·ml⁻¹ to 40 mg·ml⁻¹.

The higher loadings of GNP/GO make the use of graphene dispersion easier at the point of use as less needs to be added to reach a required loading and achieve a required response. For example at a concrete batching plant much less of the present dispersion has to be added within the process meaning existing hardware and software can be used, meaning no disruption to existing batching processes.

No additional surfactant is needed in order to achieve a stable dispersion with these ingredients when the present methods are used. Therefore in some embodiments no further surfactant is included in the dispersion. In some embodiments the dispersion may be substantially free of sodium cholate. In some embodiments, the dispersion consists of (a) graphene nanoplatelets; (b) graphene oxide nanoplatelets; and (c) water, wherein the concentration of graphene nanoplatelets in the additive is from 29 mg·ml⁻¹ to 150 mg·ml⁻¹ and the concentration of graphene oxide nanoplatelets in the additive is from 1 mg·ml⁻¹ to 50 mg·ml⁻¹, the balance being water.

The total graphene material content of the present dispersions can be calculated by simple addition of the contents of all the graphene-based components present. For example, GNP content+GO content.

It may be preferred that the total graphene material content is 30 mg·ml⁻¹ or greater. As it is understood by the inventors that having a greater amount of graphene material present helps deliver that material efficiently (smaller amount of dispersion needed to give the same addition of graphene materials), it is more preferable for the total graphene material content to be 40 mg·ml⁻¹ or greater, for example 50 mg·ml⁻¹ or greater, and most preferable for it to be 70 mg·ml⁻¹ or greater, for example 90 mg·ml⁻¹ or greater.

Stable dispersions including such concentrations of graphene material have not been known in the prior art. Nor have methods which could make such dispersions.

The ratio of content of GNP and GO in the dispersion is also of interest. In some circumstances, it may be preferable to include, for example, less GO as a proportion of GNP; that is, to use a lower concentration ratio of graphene oxide nanoplatelets to graphene nanoplatelets, graphene oxide nanoplatelet concentration/graphene nanoplatelet concentration.

That ratio is preferably from 0.025 to 1.

[A ratio of 0.025 representing 1 part GO to 40 parts GNP; a ratio of 1 representing 1 part GO to 1 part GNP.]

The ratio may in some embodiments be towards the lower end of this range. For example, it may be 0.025 to 0.5, more preferably 0.03 to 0.3, yet more preferably 0.04 to 0.2, and most preferably 0.05 to 0.1.

In some other embodiments, a higher ratio may be used, for example 0.05 to 0.7, more preferably 0.1 to 0.25.

In yet further embodiments, a yet higher ratio may be used, for example 0.5 to 1, more preferably 0.6 to 0.8.

It may be recognised that GO can act as a thickener, effectively increasing the viscosity of the dispersion. Accordingly, the amount of GO included may be moderated to achieve a desirable viscosity as well as desirable dispersion characteristics.

Of course, where a higher viscosity is desired a higher content of GO can be used.

While GNP and GO exist in various shapes and sizes, it has been found that the size of flakes used has some effect on the benefits provided by the additive. In particular a higher lateral size of GNP and a lower lateral size of GO have each individually been found to be beneficial.

For example, it may be preferred for the GNP to have an average lateral flake dimension of greater than 1 μm, more preferably greater than 10 μm.

Equally and separately, it may be preferred from the GO to have an average lateral flake dimension of less than 0.9 μm.

The lateral flake dimension of a given flake can be measured by, for example, SEM. Both GNP and GO, as well as suitable precursors, are routinely supplied by manufacturers with information about the flake sizes contained. For example, where a GNP product says that the lateral flake dimension is less than 30 μm, it can be assumed that substantially all flakes within that product have a size smaller than 30 μm.

[Generally the lateral flake “dimension” is the longest dimension of the flake. The “average” lateral flake dimension may suitably be the d₅₀.]

### Manufacture of Additive

It has previously been impossible to provide dispersions of the type described above, with GNP substantially uniformly dispersed within, in a stable form. The present inventors have found methods which allow just such dispersions to be formed, with stability radically improved as compared to previously described dispersions.

At its broadest, the present methods use high shear mixing to combine graphene oxide (or a precursor thereof), graphene nanoplatelets (or a precursor thereof) and water. More particularly, the present methods involve (i) mixing graphene oxide nanoplatelets, or a graphene oxide precursor material, with water; (ii) mixing at high shear at at least 4000 rpm for at least 15 minutes; (iii) adding graphene nanoplatelets, or a graphene precursor material; and (iv) mixing at high shear at at least 4000 rpm for at least 15 minutes, wherein the steps may be performed in the order (i), (ii), (iii), (iv) or in the order (iii), (iv), (i), (ii).

This use of high shear mixing is in contrast to the, for example, ultrasonication mixing techniques that have previously been deployed. Surprisingly it permits stable dispersions of much higher GNP (and GO) concentration to be formed.

As the graphene oxide nanoplatelets used in step (i), there is no significant limitation to their form. The preferences and features discussed above with respect to the additive itself of course still apply. In some embodiments, it may be practical to provide the graphene oxide in the form of a wet cake; that may have a GO solids content of 30 wt %-60 wt %. However it will be appreciated that the important value is how much GO is mixed with how much water, to give a final concentration of GO, rather than the form in which it is before addition.

As an alternative, a graphene oxide precursor can be used in the present methods. Suitable precursors include, for example, graphite oxide or other materials which can form graphene oxide by exfoliation. The inventors believe that such precursors can be exfoliated by the high shear mixing in step (ii), leading to the effective formation of graphene oxide nanoplatelets in situ during mixing.

As the graphene nanoplatelets used in step (iii), there is again no significant limitation to their form. The preferences and features discussed above with respect to the additive itself of course still apply. In some embodiments, it may be practical to provide the graphene nanoplatelets in the form of a powder.

Again, the amount of graphene added in step (iii) is suitably chosen to provide the desired final concentration in the additive, and in concert with the amount of graphene oxide added in step (i) to provide the desired concentration ratio of graphene oxide and graphene.

As an alternative, a graphene precursor can be used in the present methods. Suitable precursors include, for example, graphite or other materials which can form graphene by exfoliation. The inventors believe that such precursors can be exfoliated by the high shear mixing in step (ii), leading to the effective formation of graphene nanoplatelets in situ during mixing.

Mixing at at least 4000 rpm, under high shear, has been found to provide a stable dispersion; performing the mixing for at least 15 minutes in each mixing step reinforces that.

It will of course be apparent that higher mixing rates can be used, usually in the range 4000-20000 rpm, for example 5000-8000 rpm.

The high shear mixing may preferably (in one or both of steps (ii) and (iv)) be performed under conditions such that the shear rate is at least 1.5×10⁴ s⁻¹, preferably at least 2×10⁴ s⁻¹, for example at at least 4×10⁴ s⁻¹.

In preferred embodiments, the mixing time in each of steps (ii) and (iv) may independently be at least about 30 minutes, for example at least about 45 minutes, or more preferably at least about 1 hour. Suitably, mixing in each of steps (ii) and (iv) is performed for about 1 hour.

### Uses of the Graphene Dispersion

The presently described graphene dispersions can be useful for inclusion in a variety of other compositions and materials.

One particular usage is as an additive to mixtures including a cementitious material. Such mixtures may be for example to form concrete, mortar, grout etc. Such mixtures generally include the cementitious material, water, and at least one form of aggregate (for example a fine aggregate such as sand and/or a coarse aggregate such as gravel). Such mixtures and ingredients are extremely well known in the art.

The present dispersions might also be added to a variety of other mixtures to introduce graphene and improve certain properties; for example added into coating mixtures, mixed with resin for use in fiber reinforced plastics, or used in the formation of aerogels or membranes.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

### EXAMPLES

### Example 1—Dispersion

Graphite oxide was obtained from The 6^{th} Element (https://www.c6th.com/), product SE2430W—N, as a wet cake with approximately 45% solids content.

GNP were sourced from Versarien, product GNP-HP.

69 g of the graphite oxide wet cake was placed into a glass beaker, and approximately 700 ml of tap water added to it. The mixture was then mixed in a high shear mixer for approximately 1 hour (Silverson high shear mixer with a Square Hole High Shear Screen™ at 5000 rpm).

After this mixing, 69 g of the GNP powder was added in four aliquots, with approximately 30 seconds of manual mixing between additions.

Once all the GNP had been added, the final mixture was then mixed in a high shear mixer for approximately 1 hour (Silverson high shear mixer with a Square Hole High Shear Screen™ at 5000 rpm).

The resulting mixture (apx 1 litre) was found to be stable under standard conditions for more than 6 months.

### Example 2—Stability Testing

### Example 2a

Following the general experimental method set out in Example 1, a dispersion was made including 7% total graphene concentration (70 mg·ml⁻¹), with a GO:GNP concentration ratio of 0.25 (that is, 4:1 in terms of GNP:GO).

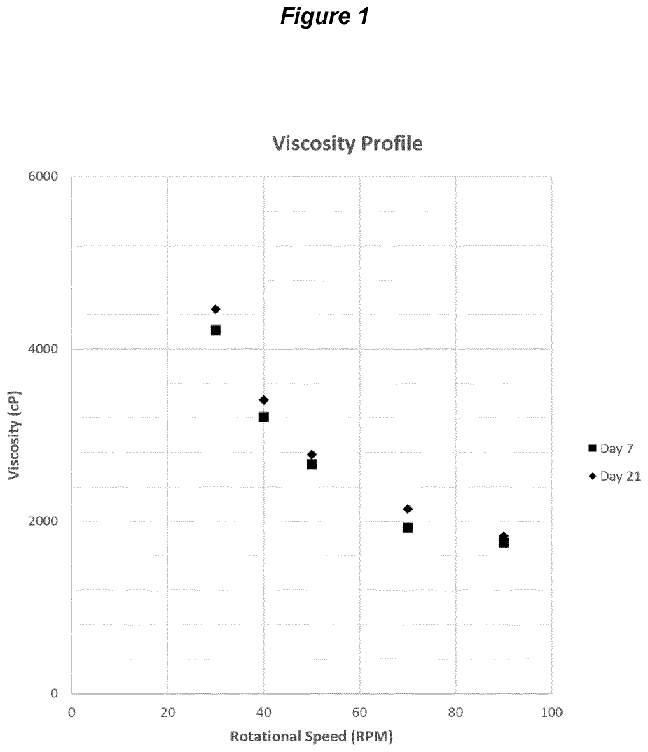

Viscosity (cP) of the resultant dispersion was measured using a DV2T viscometer from AMETEK Brookfield, LV model, at a variety of different rpm counts. Data are shown in FIG. 1 indicating viscosity profiles at day 7 and day 21. It can be seen that, despite the long time between the readings, the viscosity profile of the dispersion did not significantly change, indicating a long term stability of the dispersion. Viscosity was broadly stable (within about 15%) for each of 30 rpm, 40 rpm, 50 rpm, 70 rpm and 90 rpm.

### Example 2b

Following the general experimental method set out in Example 1, a dispersion was made including 10% total graphene concentration (100 mg·ml⁻¹), with a GO:GNP concentration ratio of 0.25 (that is, 4:1 in terms of GNP:GO).

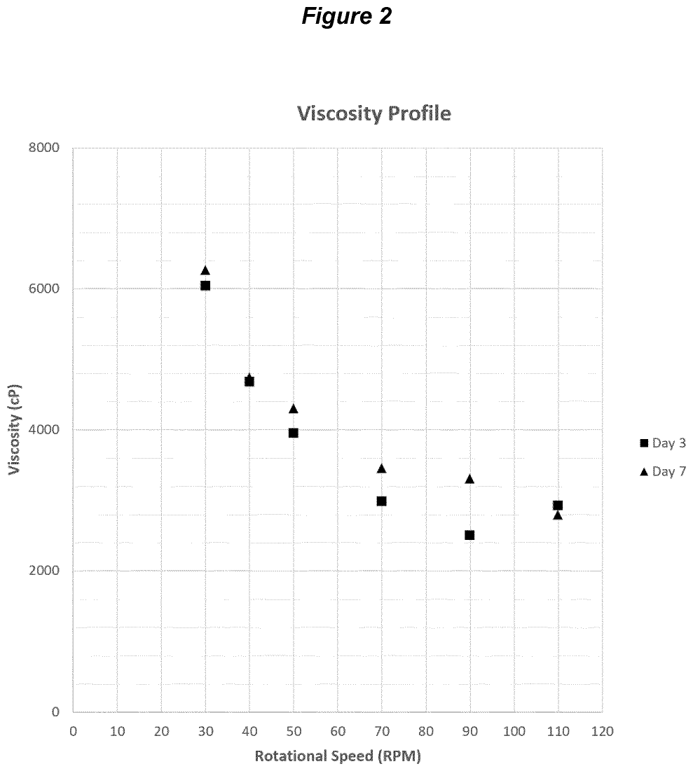

Viscosity (cP) of the resultant dispersion was measured using a DV2T viscometer from AMETEK Brookfield, LV model, at a variety of different rpm counts. Data are shown in FIG. 2 indicating viscosity profiles at day 3 and day 7. It can be seen that, despite the long time between the readings, the viscosity profile of the dispersion did not significantly change, indicating a long term stability of the dispersion. Viscosity was broadly stable (within about 15%) for each of 30 rpm, 40 rpm, 50 rpm, 70 rpm and 110 rpm. The relatively significant change in viscosity at 90 rpm is considered anomalous.

1. A graphene dispersion, comprising:
(a) graphene nanoplatelets;
(b) graphene oxide nanoplatelets; and
(c) water,
wherein the concentration of graphene nanoplatelets in the additive is from 29 mg·ml⁻¹ to 150 mg·ml⁻¹ and the concentration of graphene oxide nanoplatelets in the additive is from 1 mg·ml⁻¹ to 50 mg·ml⁻¹.

2. The dispersion according to claim 1, wherein the graphene nanoplatelets have an average lateral flake dimension of greater than 1 μm.

3. The dispersion according to claim 1, wherein the graphene nanoplatelets have an average lateral flake dimension of greater than 10 μm.

4. The dispersion according to claim 1, where the graphene oxide nanoplatelets have an average lateral flake dimension of less than 0.9 μm.

5. The dispersion according to claim 1, wherein the concentration ratio of graphene oxide nanoplatelets to graphene nanoplatelets, calculated as graphene oxide nanoplatelet concentration/graphene nanoplatelet concentration, is from 0.025 to 1.

6. A method of making a graphene dispersion, the method comprising the steps of:
(i) mixing graphene oxide nanoplatelets, or a graphene oxide precursor material, with water;
(ii) mixing at high shear at at least 4000 rpm for at least 15 minutes;
(iii) adding graphene nanoplatelets, or a graphene precursor material; and
(iv) mixing at high shear at at least 4000 rpm for at least 15 minutes;
wherein the steps are carried out in the order (i), (ii), (iii), (iv) or (iii), (iv), (i), (ii).

7. A method according to claim 6, wherein in step (i) a graphene oxide wetcake or a graphite oxide wetcake is mixed with the water.

8. A method according to claim 6, wherein in step (ii) mixing is performed for at least 45 minutes, preferably about 1 hour.

9. A method according to claim 6, wherein in step (iii) a graphene nanoplatelets powder is added.

10. A method according to claim 6, wherein in step (iv) mixing is performed for at least 45 minutes, preferably about 1 hour.

11. A method according to claim 6, wherein in step (iv) graphene nanoplatelets with an average lateral flake dimension of greater than 1 μm, preferably greater than 10 μm, are used.

12. A method according to claim 6, wherein in step (i) graphene oxide nanoplatelets or graphite oxide with an average lateral flake dimension of less than 0.9 μm are used.

13. A method according to claim 6, wherein in step (i) the graphene oxide nanoplatelets or graphene oxide precursor material is added in an amount to give a graphene oxide nanoplatelet concentration of from 1 mg·ml⁻¹ to 50 mg·ml⁻¹ in the additive for inclusion in concrete.

14. A method according to claim 6, wherein in step (iii) the graphene nanoplatelets or graphene precursor material is added in an amount to give a graphene nanoplatelet concentration of from 29 mg·ml⁻¹ to 150 mg·ml⁻¹ in the additive for inclusion in concrete.

15. A method according to claim 6, wherein in steps (i) and (iii) the graphene oxide nanoplatelets or graphene oxide precursor material, and the graphene nanoplatelets or graphene precursor material, are added in an amount to give a concentration ratio of graphene oxide nanoplatelets to graphene nanoplatelets, calculated as graphene oxide nanoplatelet concentration/graphene nanoplatelet concentration, from 0.025 to 1 in the dispersion.
